(19) United States
(12) Patent Application Publication
(10) Pub. No.: US 2024/0271465 A1
(43) Pub. Date: Aug. 15, 2024

(54) ROLL-UP DOOR LOCK

(71) Applicant: ASSA ABLOY Residential Group, Inc., New Haven, CT (US)

(72) Inventors: Mark Caterino, Prospect, CT (US); Vu Nguyen, Farmington, CT (US); Wai P. Wong, Orange, CT (US)

(73) Assignee: ASSA ABLOY Residential Group, Inc., New Haven, CT (US)

(21) Appl. No.: 18/320,134

(22) Filed: May 18, 2023

Related U.S. Application Data
(60) Provisional application No. 63/484,662, filed on Feb. 13, 2023.

(51) Int. Cl. E05B 65/00; E05B 47/00; G07C 9/00

(52) U.S. Cl. CPC E05B 65/0021; E05B 47/0001; G07C 9/00309; G07C 2009/00634

(57) ABSTRACT

Aspects disclosed herein relate to roll-up door locks for roll-up doors. Roll-up door locks may comprise a latch configured to be moved between a latched and an unlatched position as well as a blocker configured to be moved between a blocking and an unblocking position such that in the blocking position, movement of the latch is restricted by the blocker. An electromechancial actuator may be coupled to the blocker to move the blocker between the blocking and unblocking positions. An authentication device may be implemented in the roll-up door lock to validate a credential associated with a user and to in turn send commands to the actuator to move the blocker between the blocking and unblocking positions. In some embodiments, the roll-up door lock may be powered through the use of inductive coupling from a remote device.

### RELATED APPLICATIONS

This application claims the benefit of priority under 35 U.S.C. § 119(e) to U.S. Provisional Application No. 63/484,662, filed on Feb. 13, 2023, which is herein incorporated by reference in its entirety.

### FIELD

Disclosed embodiments are related to roll-up door locks and related methods of use.

### BACKGROUND

Low profile roll-up door locks are commonly employed on doors for storage lockers, garages, or other enclosures where a door moves in a vertical direction to open and close.

### SUMMARY

According to one aspect of the invention, a roll-up door lock for a roll-up door is provided. The roll-up door lock may include a latch configured to move between a latched position and an unlatched position. The roll-up door lock may also include a blocker configured to move between a blocking position and an unblocking position. In the blocking position, the blocker may prevent movement of the latch from the latched position to the unlatched position. The roll-up door lock may also include an actuator that may be coupled to the blocker to selectively move the blocker between the blocking position and the unblocking position. The roll-up door lock may also include an authentication device configured to receive a credential and configured to determine whether the credential is valid. Upon determination that the credential is valid, the authentication device may command the actuator to move the blocker to the unblocking position.

According to another aspect of the invention, a method for operating a roll-up door lock for a roll-up door is provided. The method may include moving a blocker between a blocking position and an unblocking position using an actuator coupled to the blocker. The method may also include blocking movement of the latch from a latched position to an unlatched position when the blocker is in the blocking position. The method may also include authenticating a credential received at an authentication device to determine whether the credential is valid. Upon determination that the credential is valid, the authentication device may send a command to the actuator to move the blocker to the unblocking position. The method may further include allowing movement of the latch from the latched position to the unlatched position when the blocker is in the unblocking position.

According to another aspect of the invention, a roll-up door lock for a roll-up door is provided. The roll-up door lock may include a latch configured to move between a latched position and an unlatched position. The roll-up door lock may also include a blocker configured to move between a blocking position and an unblocking position. In the blocking position, the blocker may prevent movement of the latch from the latched position to the unlatched position. The roll-up door lock may also include an actuator that may be coupled to the blocker to selectively move the blocker between the blocking position and the unblocking position. The roll-up door lock may also include an inductive coupler configured to create an inductive coupling with a remote device. The inductive coupling may provide electrical energy to energize the actuator and the remote device may be configured to cause the actuator to move the blocker to the unblocking position.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a first side perspective view of one embodiment of a roll-up door lock;

FIG. 2 is a second side perspective view of the roll-up door lock of FIG. 1;

FIG. 3 is a second side perspective view of the roll-up door lock of FIG. 1 with a front cover removed;

FIG. 4 is a schematic of the roll-up door lock of FIG. 1 communicating with a plurality of local and remote devices;

FIG. 5 is a first side perspective view of another embodiment of a roll-up door lock;

FIG. 6 is a second side perspective view of the roll-up door lock of FIG. 5;

FIG. 7 is a first side perspective view of the roll-up door lock of FIG. 5 on a roll-up door;

FIG. 8 is a second side perspective view of the roll-up door lock of FIG. 5 on a roll-up door;

FIG. 9 is a first side perspective view of another embodiment of a roll-up door lock;

FIG. 10 is a second side perspective view of the roll-up door lock of FIG. 9;

FIG. 11 is a perspective view of an embodiment of a blocking mechanism for a roll-up door lock in an unlocked state;

FIG. 12 is a perspective view of the blocking mechanism of FIG. 11 in a locked state;

FIG. 13 is a perspective view of an embodiment of a blocking mechanism for a roll-up door lock in an unlocked state;

FIG. 14 is a perspective view of the blocking mechanism of FIG. 13 in a locked state;

FIG. 15 is a perspective view of yet another embodiment of a portion of a roll-up door lock;

FIG. 16 is a perspective view of an embodiment of a blocking mechanism for use with the roll-up door lock of FIG. 15;

FIG. 17 is a perspective view of another embodiment of a blocking mechanism for use with the roll-up door lock of FIG. 15;

FIG. 18 is a perspective view of yet another embodiment of a blocking mechanism;

FIG. 19 is a schematic view the blocking mechanism of FIG. 18;

FIG. 20 is a perspective view of yet another embodiment of a roll-up door lock in an unlocked state;

FIG. 21 is a perspective view of the roll-up door lock of FIG. 20 in a locked state;

FIG. 22 is a block diagram of one embodiment for a method of operating a roll-up door lock according to exemplary embodiments described herein;

FIG. 23 is another embodiment of a roll-up door lock that is energized and operated through the use of inductive coupling;

FIG. 24 is a perspective view of an embodiment of a roll-up door lock configured as a padlock in an unlocked state; and

FIG. 25 is a perspective view of the roll-up door lock of FIG. 24 in a locked state.

### DETAILED DESCRIPTION

Roll-up door locks are commonly employed on roll-up doors. Roll-up doors are often employed in storage lockers, garages, warehouses, and other enclosures to allow a door to be opened vertically. Some roll-up doors coil around a reel disposed at the top of the doorway, or otherwise fit into a confined space when in an open position. Accordingly, locks for roll-up doors are typically limited to low-profile latches which are secured with a removable lock. Such locking arrangements may be susceptible to forced entry techniques and may restrict access to manual keys which limits flexible accessibility of a roll-up door secured by conventional methods.

In view of the above, the inventors have recognized the benefits of a roll-up door lock which includes an actuator (e.g., an electromechanical actuator such as a motor, servo, linear actuator, etc.) and an authentication device (e.g., RFID reader, NFC reader, keypad, wireless chip, smartphone, PDA, tablet, laptop computer, desktop computer, etc.) which allows a roll-up door lock to be easily accessed by authorized users possessing one or more valid credentials. Such a roll-up door lock may allow features such as temporary access granting, revoking access, timed access, and other management features which are lacking from conventional roll-up door locks. The roll-up door lock may communicate with a remote server to facilitate management of a plurality of roll-up door locks (e.g., in a storage facility). The roll-up door lock may replace existing roll-up door locks or may be retrofit to existing roll-up door locks. In either case, roll-up door locks of exemplary embodiments described herein do not interfere with the motion of the roll-up door as it moves between open and closed positions. Further, the roll-up door lock according to some embodiments may be mounted to the roll-up door. In one embodiment, the roll-up door lock is configured to be, and in one embodiment is, mounted within a channel of the roll-up door, such as the recessed portion of a corrugated door face. In some embodiments, the roll-up door lock may be configured as a padlock, and the padlock may be removably secured to the roll-up door. For example, the padlock may be secured to a latch of the roll-up door.

The inventors have appreciated that in some embodiments, power sources such as batteries, capacitors, or wired power sources may be used to provide power to various components of the roll-up door lock including, but not limited to the actuator, the authentication device, and any implemented controllers. However, the inventors have found that such power sources may be subject to certain drawbacks. For example, use of a battery in a roll-up door lock may require routine replacement and/or recharging of the battery. In another example, the use of a wired power source may limit the locations where a roll-up door lock may be used, as such power sources require nearby electrical outlets or other hardwired power sources to provide electrical energy.

In view of the above, the inventors have recognized benefits associated with a roll-up door lock which is energized and operated through the use of inductive coupling. In some embodiments, an inductive coupler of the roll-up door lock may form an inductive coupling with a remote device (e.g., a smartphone) to energize the roll-up door lock components (e.g., an authentication device and/or an actuator). In some such embodiments, the remote device may include a near field communication (NFC) reader configured to communicate with the roll-up door lock through an NFC chip (e.g., a tag) provided in the lock. The NFC chip in the lock may be a dynamic (dual-interface) NFC tag capable of two-way communication with the NFC reader in the remote device. In other embodiments, however, the NFC chip in the lock may be a single-interface NFC tag configured to passively exchange data with the NFC reader in the remote device. In some embodiments, the NFC reader in the remote device may energize the NFC chip in the lock, providing a power to the lock via an inductive coupling. In such embodiments, the NFC reader within the remote device may be a charging transmitter (e.g., a poller), while the NFC chip in the lock is a charging receiver (e.g., a listener). In some embodiments, such an inductive coupling may provide up to approximately 1 W of power to the lock (e.g., between 0 W and 1 W). Additionally or alternatively, a radio frequency identifier (RFID) reader within a remote device may be used to energize an RFID circuit provided in the roll-up door lock. As yet another example, in some embodiments, a remote device may include an ultrawideband (UWB) chip configured to energize an UWB chip in the roll-up door lock. In some embodiments, the inductive coupling provided from a remote device to the roll-up door lock may be the sole power source for powering the lock. In other embodiments, however, inductive coupling may be used in conjunction with other power sources such as batteries, capacitors, and/or wired power sources to energize and operate the roll-up door lock. In some embodiments, the inductive coupler within the lock may form a portion of a controller for the lock. Signals or information from the tag or chip within the lock may be utilized for exchanging data to the NFC reader. For example, the tag or chip within the lock may exchange data relating to credentials, diagnostic information, access information, or any other suitable data to the NFC reader in the remote device.

It should be noted that while some embodiments herein employ inductive couplers of a specific type (e.g., RFID, NFC, UWB), any suitable inductive coupling standard or other wireless power transfer arrangement may be employed, as the present disclosure is not so limited. In some embodiments, an inductive coupler may be a coil of wire that may generate a magnetic field when current is transmitted through the coil (e.g., to wirelessly transmit power), or may generate a current in response to a magnetic flux (e.g., to wirelessly receive power). In some embodiments herein, a roll-up door lock may include an inductive coupler configured as a coil of wire configured to generate and electric current in response to a magnetic flux through the coil. The magnetic flux may be generated by a corresponding coil in a remote device, such as a smartphone.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

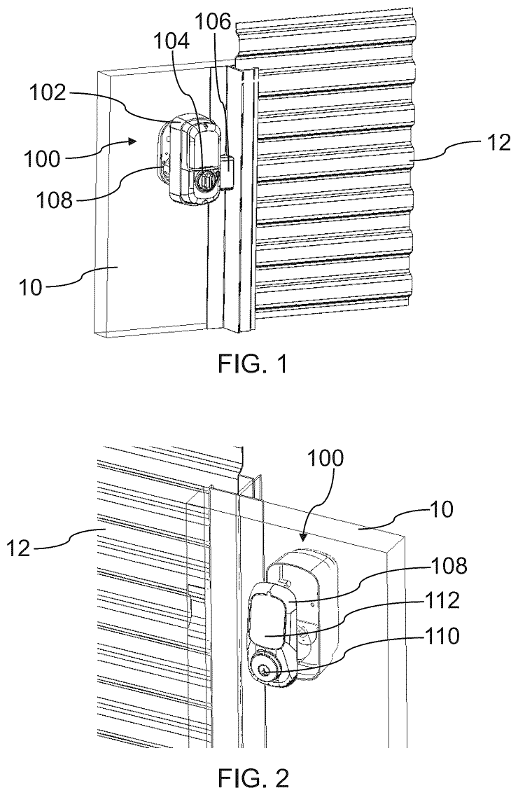

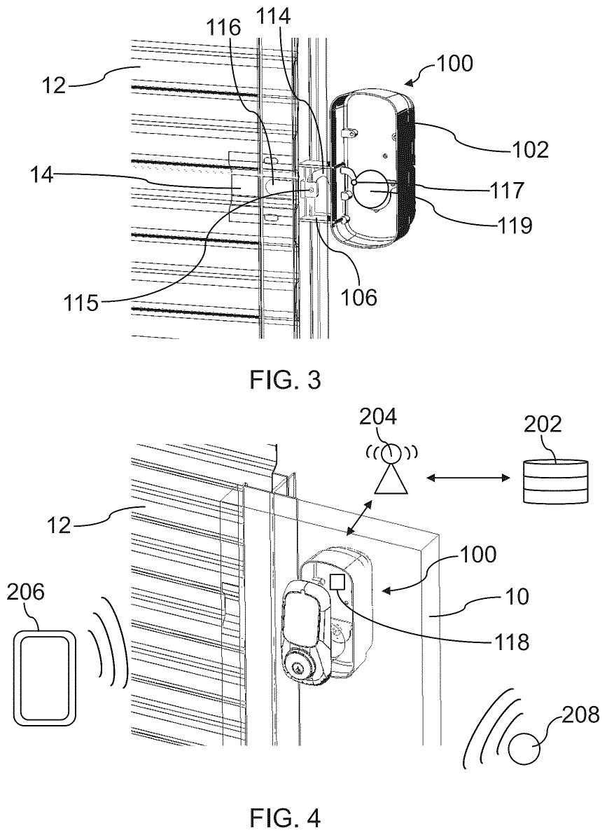

FIG. 1 is a first side perspective view of one embodiment of a roll-up door lock 100. As shown in FIG. 1, the roll-up door lock is disposed in a wall 10 adjacent the roll-up door 12. The wall 10 is shown as being transparent for the sake of clarity. The roll-up door lock engages the roll-up door through guide 106, as will be discussed further with reference to FIG. 3. The roll-up door lock includes an interior chassis 102 and a manual release 104. The interior chassis and manual release are disposed on an interior, secured side of the roll-up door, and the manual release may be operated to lock or unlock the roll-up door lock from the secured side of the roll-up door. The roll-up door lock also includes an exterior chassis 108 which is accessible from an exterior, unsecured side of the roll-up door.

FIG. 2 is a second side perspective view of the roll-up door lock 100 of FIG. 1. As shown in FIG. 2, the roll-up door lock includes an exterior chassis 108. Disposed in the exterior chassis are a key override 110 and an authentication device 112. According to the embodiment of FIG. 2, the authentication device is configured as and RFID/NFC reader and is configured to communicate with passive RFID tags as well as NFC chips disposed in remote devices such as cellular telephones and smart watches. The authentication device is configured to communicate with an actuator and command the actuator to selectively move a latch (see FIG. 3) between latched and unlatched positions. Likewise, the key override 110 is coupled to the latch to allow a standard key to be used to operate the latch in cases of power loss or other unforeseen circumstances.

FIG. 3 is a second side perspective view of the roll-up door lock of FIG. 1 with a front cover removed. As shown in FIG. 3, the roll-up door lock includes a latch 116 which moves between latched and unlatched positions. In the latched position, the latch is disposed in a latch cover 14 attached to the roll-up door so that the latch contacts the cover and prevents the roll-up door from being opened. The latch is coupled to the roll-up door lock via a linkage 114 via a first pin 115. The linkage is also coupled to a rotary element 119 via a second pin 117. The rotary element is configured to be rotated by the actuator or the key override (not shown in the figure) to move the latch between the latched and unlatched positions. According to the embodiment of FIG. 3, the rotary element rotates clockwise from the position shown to move the latch to the unlatched position.

FIG. 4 is a schematic of the roll-up door lock of FIG. 1 communicating with a plurality of local and remote devices. According to the embodiment of FIG. 4, the roll-up door lock is configured to communicate with credential devices and a remote server (e.g., cloud service) to enable digital management and access of the secured roll-up door. As noted previously, the authentication device communicates with a remote device 206 via NFC or Bluetooth and a passive RFID tag 208. In some embodiments, the remote device is a mobile device such a smartphone, smartwatch, etc. A communication module 118 (which may be integrated with or distinct from the authentication device) communicates with a remote server 202 via a network 204, such as a local area network, wide area network, cellular network, satellite network, or any other suitable network through any suitable protocol such as Wi-Fi, Ethernet, CDMA, LTE, etc. The remote server may transmit commands to the roll-up lock such as lock/unlock commands, setting alteration commands, credential verification commands, etc. The remote server may also receive information from the roll-up lock such as credentials, diagnostic information, access information, etc. The remote server may also allow remote or local communication with the roll-up lock (e.g., via a personal computer or mobile device) so that the roll-up lock may be locked or unlocked from the remote device.

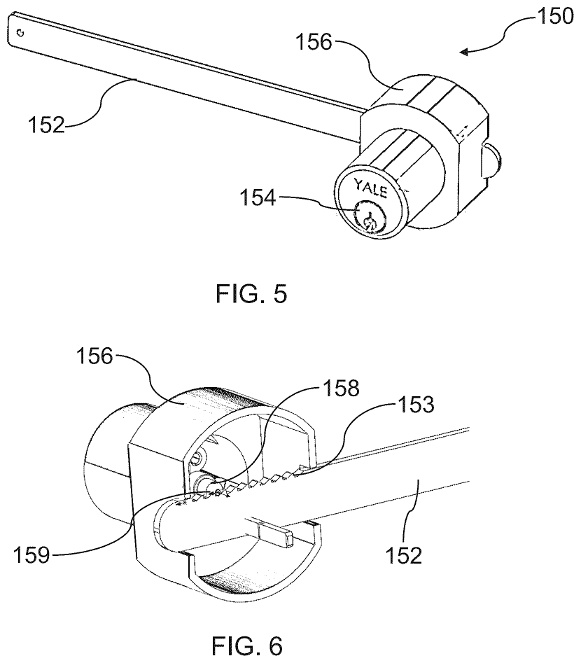

FIGS. 5-6 are first side and second side perspective views of another embodiment of a roll-up door lock 150. As shown in FIGS. 5-6, the roll-up door lock includes a latch 152, a key override 154, and a housing 156. The latch penetrates the housing 156 and is selectively blocked from moving by a blocker 159 which engages one of the plurality of locking slots 153 when the blocker is in the blocking position. The blocker is housed in a blocker carrier 158, and is arranged as a pin in the present embodiment. An actuator disposed in the housing 156 may selectively move the blocker between the blocking position and unblocking position to allow the latch to be manual retracted (e.g., via a handle). Likewise, the key override may be used with a valid key to move the blocker to the unblocking position and allow the latch to be retracted manually. The blocker and/or blocker carrier may be biased toward the blocking position (e.g., with one or more compression springs) such that the blocker progressively engages the latch upon the latch entering the housing 156.

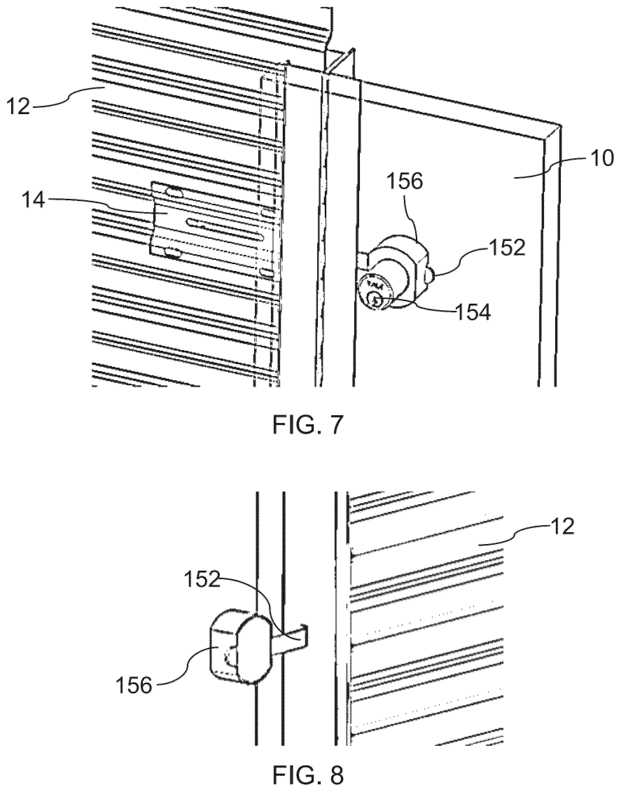

FIGS. 7-8 are first and second side perspective views of the roll-up door lock of FIG. 5 on a roll-up door. As shown in FIGS. 7-8, a latch cover 14 houses the latch and allows the latch to slide between latched and unlatched positions. In the embodiment shown, the latch cover is disposed in a channel of the roll-up door. In the latched position, the latch engages the housing 156 of the roll-up door lock so that the latch is secured by the blocker. To move the latch to the unlatched position, the blocker is moved to the unblocking position via an actuator (e.g., motor, linear actuator, servo, etc.) or the key override, whereupon the latch may be retracted manually via a handle coupled to the latch (not shown in the figure).

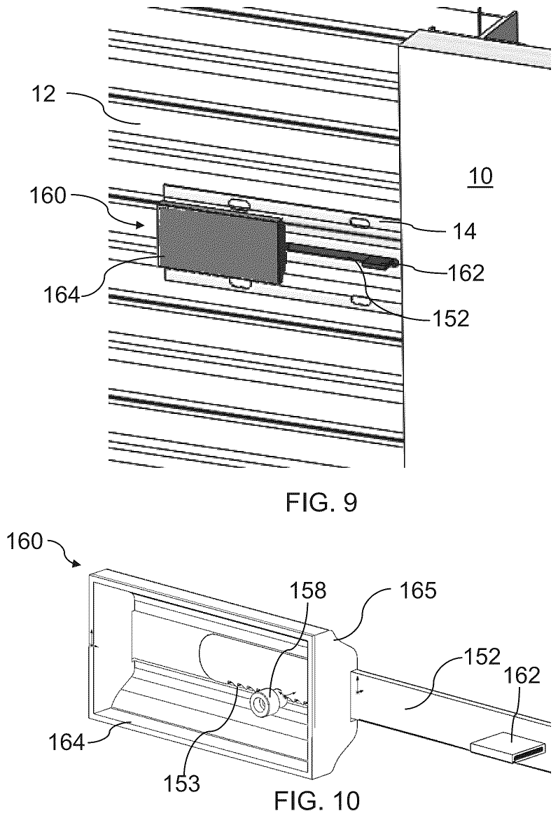

FIG. 9 is a first side perspective view of another embodiment of a roll-up door lock 160 which is disposed solely on the roll-up door. As shown in FIG. 9, the roll-up door lock includes a housing 164 which receives a latch 152 configured to slide between latched and unlatched positions. In the embodiment shown in FIGS. 9 and 10, the housing 164 is configured to be disposed in a channel of the roll-up door. In this regard, the housing is formed with a profile 165 (see FIG. 10) that generally matches the profile of the roll-up door such that the housing, and thus the lock, is formed as a low-profile lock that occupies little space and is also limited in the amount that the housing protrudes from the envelope defined by the corrugated surface of the roll-up door. In the latched position, the latch engages the wall 10 adjacent the doorway to secure the roll-up door. The latch is disposed in a latch cover 14 and includes a handle 162 which allows a user to manually slide the latch between the latched and unlatched positions when the latch is unblocked.

FIG. 10 is a second side perspective view of the roll-up door lock 160 of FIG. 9. As shown in FIG. 10, the roll-up door lock includes a blocker carrier 158 configured to receive a blocker (not shown in FIG. 10), where the blocker is configured to move between blocking an unblocking positions to selectively allow the latch 152 to move between latched and unlatched positions. In particular, in the blocking position, the blocker engages one of the plurality of locking slots 153 to prevent the latch from being moved toward the unlatched position, thereby effectively locking the roll-up door. The blocker may be controlled independently by both an actuator (e.g., a motor, linear actuator, servo, etc.) and a key override. The blocker is also biased toward the blocking position.

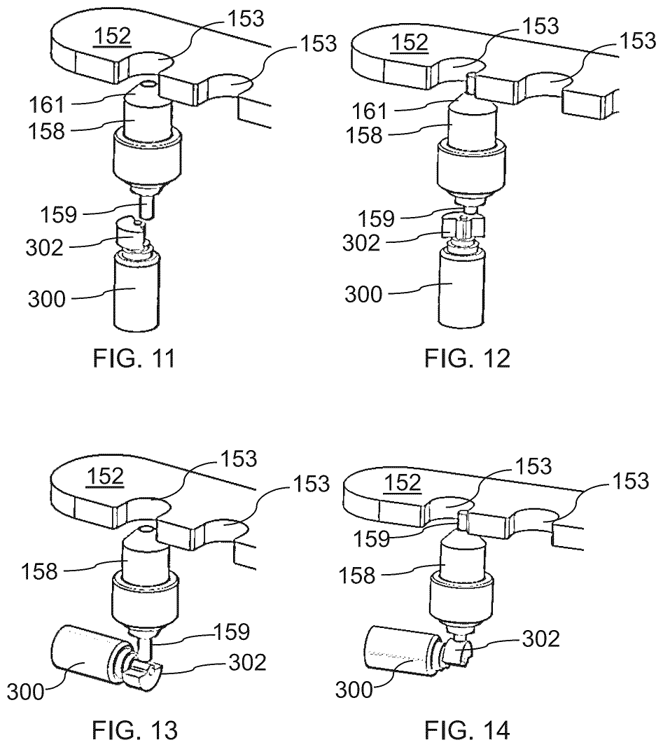

FIG. 11 is a perspective view of an embodiment of a blocking mechanism for a roll-up door lock in an unblocking state. As shown in FIG. 11, the blocking mechanism is configured to selectively block or unblock the movement of a latch 152 included a plurality of locking slots 153. The blocking mechanism includes a blocker carrier 158 and a blocker 159. The blocker carrier 158 is configured to move to a first blocker carrier position where the blocker carrier is in a path of the latch 152 (e.g., is disposed on one of the locking slots 153) and a second blocker carrier position when the blocker carrier is not in the path of the latch (e.g., as shown in FIG. 11). The blocker carrier 158 may be biased towards the latch. The blocker is moveable independently of the blocker carrier, but is biased to be aligned in the position shown in FIG. 11, where a distal portion (e.g., a distalmost end) of the blocker is aligned with a distal portion (e.g., a distalmost end) of the blocker carrier. That is, in the depicted embodiment, the blocker 159 may be biased relative to the blocker carrier 158 (e.g., with a spring) be aligned with the blocker carrier. Accordingly, when the blocker carrier 158 is moved, the blocker 159 may be biased to move with the blocker carrier 158. However, if an independent force is applied to the blocker 159, the blocker may move independently relative to the blocker carrier. As shown in FIG. 11, a proximal portion of the blocker 159 extends past a proximal portion of the blocker carrier 158.

As shown in FIG. 11, an actuator 300 controls an interference element 302 and rotates the interference element into or out of the path of the blocker 159. In the position shown in FIG. 11, the interference element is not in the path of the blocker. Accordingly, as the blocker carrier 158 moves between the first blocker carrier position and the second blocker carrier position, the blocker may move with the blocker carrier without interference from the interference element 302. According to the embodiment of FIG. 11, even if the blocker is in in a travel path the latch along with the blocker carrier (e.g., with their respective distal portions aligned), movement of the latch will cam the blocker and blocker carrier out of the way against any urging force and allow the latch to be moved to an unlatched position. That is, contact between a camming portion 161 of the blocker carrier 158 may move the blocker carrier from the first blocker carrier position to the second blocker carrier position, correspondingly moving the blocker from the blocking position to the unblocking position because the interference element 302 is not in the patch of the blocker.

FIG. 12 is a perspective view of the blocking mechanism of FIG. 11 in a blocking state. As shown in FIG. 12, the actuator 300 has moved the interference element 302 into the path of the blocker 159. Accordingly, when the latch 152 is moved, the blocker carrier 158 may be cammed out of the way but the blocker remains as it is blocked from moving with the blocker carrier by the interference element 302. The interference element 302 resists the biasing force urging the blocker toward alignment with the blocker carrier. Accordingly, the latch may not be retracted and will remain in a latched state to secure an associated roll-up door.

FIGS. 13-14 are perspective views of another embodiment of a blocking mechanism which operates on a similar principle to the mechanism of FIGS. 11-12. That is, the interference element is selectively controller by the actuator 300 to prevent movement of the blocker 159, so that the latch remains in a latched state to secure a roll-up door. In the embodiment, of FIGS. 13-14, the actuator 300 and interference element 302 are rotated 90 degrees for a more compact and low-profile actuator arrangement. In one embodiment, the actuator 300 may be a rotary motor.

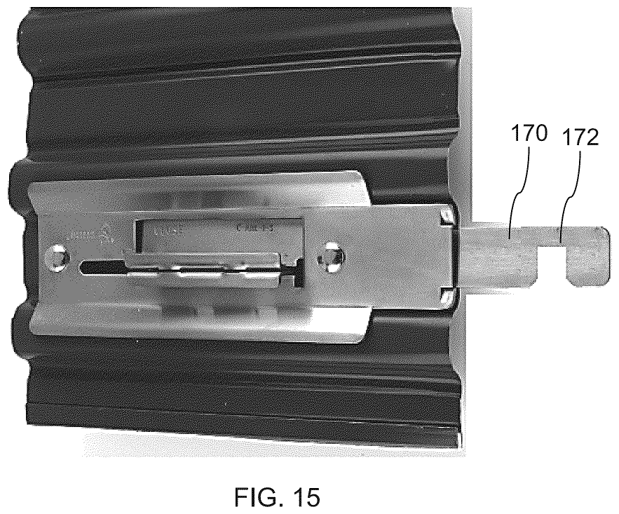

FIG. 15 is a perspective view of yet another embodiment of a roll-up door lock. The roll-up door lock includes a latch 170 having a slot 172 which may interact with various blocking mechanism embodiments as will be described further below.

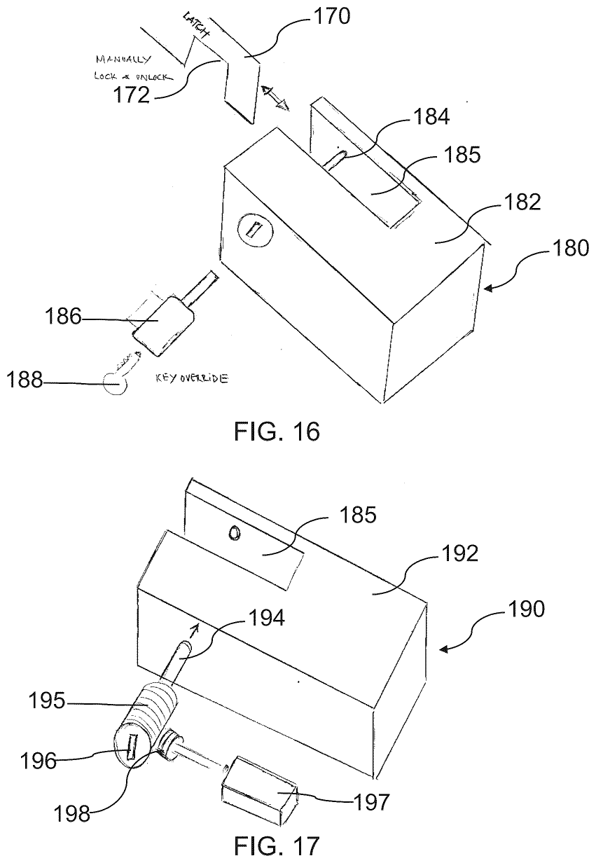

FIG. 16 is a perspective view of an embodiment of a blocking mechanism 180 for use with the roll-up door lock of FIG. 15. As shown in FIG. 16, the blocking mechanism includes a housing 182 configured to receive the latch 170. A pin 184 is configured to engage the slot 172 and is actuated by an actuator 186 which is also manually actuatable with a key 188. The actuator may include a linear motor such as a solenoid. Accordingly, the latch 170 is slid into the channel 185. Once the slot 172 aligns with the pin 184, the pin 184 can move from its retracted position out of the channel to an extended position within the channel thereby extending through the slot 172 such that the latch 170 cannot be retracted from the channel 185.

FIG. 17 is a perspective view of another embodiment of a blocking mechanism 190 for use with the roll-up door lock of FIG. 15. The roll-up door lock of FIG. 17 also includes a housing 192 configured to receive the latch 170 (not shown in FIG. 17) and a pin 194 configured to engage the slot 172 (not shown in FIG. 17) to prevent movement of the latch to an unlatched position. A threaded body 195 linearly translates the pin into or out of engagement with the latch and may be overridden with a key override 196. An actuator 197 is coupled to the threaded body via a gear 198 that is configured to rotate the threaded body to move the pin as well. In this embodiment, the actuator 197 may be a rotary motor.

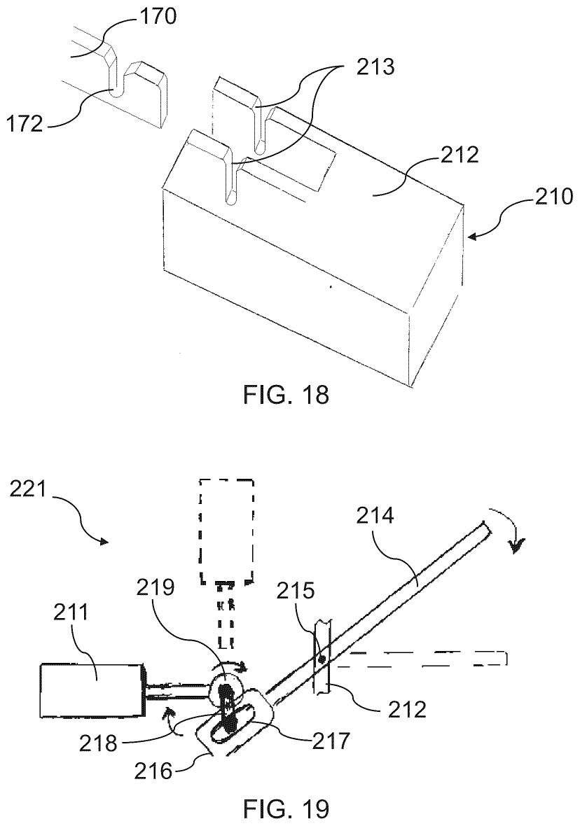

FIGS. 18 and 19 show another embodiment of a blocking mechanism. The blocking mechanism 210 includes a housing 212 (as shown in FIG. 18) and an actuator assembly 221 (as shown in FIG. 19). Slots 213 which are configured to align with slot 172 of the latch when the latch is received in the housing. A hinged pin is configured to engage both the slots 213 in the housing and the slot 172 in formed in the latch. The blocking mechanism further includes an actuator assembly.

FIG. 19 is a schematic view of the blocking mechanism of FIG. 18. As shown in FIG. 19, a pin 214 is configured to engage slots 172, 213 disposed in the latch 170 and housing 212, respectively, to prevent retraction of the latch. The pin 214 is coupled to the housing 212 at pin hinge 215 about which the pin is rotated. In this respect, the pin 214 acts as a gate that engages with slot 172. The pin is coupled to a cam block 216 on an end opposite the housing 212, which is manipulated to move the pin between a blocking position (e.g., where the pin is rotated down in FIG. 19 so as to become disposed in the slots and prevents latch retraction) and an unblocking position (e.g., where the pin rotated upward in FIG. 19 so as to be positioned outside the slots and the latch is able to be retracted). The cam block 216 includes a cam slot 217 which contains a first end 218 of a linkage. A second end 219 of the linkage is coupled to and actuator 211. The actuator is configured as a motor which rotates the linkage in a clockwise direction (as shown by the arrows) or counterclockwise direction to move the cam block 216 and to rotate the pin 214 about the pin hinge 215. That is, as the linkage is rotated in a clockwise direction, the first end 218 of the linkage engages the cam slot 217 and pushes the cam block down relative to the page. Accordingly, the pin 214 rotates in a counterclockwise direction and the pin is lifted out of the slots 172, 213. To reverse the motion of the pin, the linkage may be further rotated in a clockwise direction and the second end 219 of the linkage engages the cam slot 217 to lift the cam block, thereby rotating the pin in a clockwise direction. As the pin 214 rotates in a clockwise direction, the pin is lowered into engagement with the slots 213, 172 (e.g., moved into the blocking position). The actuator 211 may be positioned in a variety of positions so that the overall volume of the blocking mechanism may be minimized to fit onto or adjacent to a roll-up door. For example, the actuator 211 may be positioned in the location shown in dashed lines.

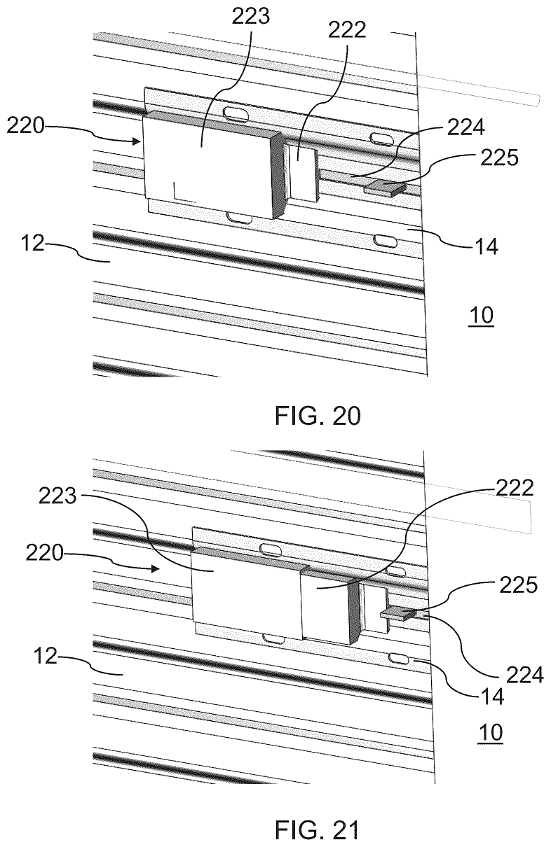

FIG. 20 is a perspective view of yet another embodiment of a roll-up door lock 220 in an unlocked state. As shown in FIG. 20, the roll-up door lock includes a housing 223 which is mounted to a roll-up door 12. More specifically, the roll-up lock is mounted adjacent to a latch cover 14 which houses a latch 224 which is movable between a latched and unlatched position. In the latched position, the latch enters an adjacent wall 10 to prevent the roll-up door from moving to an open position. The latch is slidable in the latch cover and may be manually actuated with a handle 225 when the roll-up lock is in the unlocked state shown in FIG. 20. According to the embodiment of FIG. 20, the roll-up lock includes a blocker 222 which is coupled to a linear actuator disposed inside the housing 223. The blocker is configured to move between a blocking position (see FIG. 21) and an unblocking position to selectively prevent the movement of the latch 224 from a latched position to an unlatched position, thereby effectively securing the door. The roll-up lock of FIG. 20 may include an authentication device such as a card reader, an NFC chip, or a wireless communicator (e.g., Bluetooth chip, Wi-Fi chip, 802.15.4 radio), which is able to communicate with an external device to receive a valid credential. When the valid credential is received, the linear actuator may be used to move the blocker to the blocking position or unblocking position so that the roll-up door may be secured or unsecured, respectively. The linear actuator and authentication device may be powered with a battery, capacitor, or wall power, in some embodiments. As discussed further below with reference to FIG. 23, in some embodiments the linear actuator and authentication device may be powered by an inductive coupler, such that the linear actuator and authentication device receive power from a remote device wirelessly. The roll-up lock may also include a manual key override, so that the roll-up lock may be actuated in cases of power loss or as an alternate entry method.

FIG. 21 is a perspective view of the roll-up door lock of FIG. 20 in a locked state. As shown in FIG. 21, the blocker 22 is in the blocking position and has occupied the space between the housing 223 and the handle 225, so that the handle may not be moved to move the latch to the unlatched position (e.g., left relative to the page). Accordingly, in the position shown in FIG. 21, the door is secured and may not be opened without first moving the blocker 222 to the unblocking position shown in FIG. 20. Accordingly, to open the door from the state shown in FIG. 21, a valid credential may be received at the authentication device of the roll-up door lock, whereupon the linear actuator may retract the blocker to move the blocker to the unblocking position. Alternatively, a key may be used in a key override cylinder to manually move the blocker to the unblocking position.

According to the embodiment shown in FIG. 21, the blocker 222 may also be used to move latch 224 to the latched position. That is, when the latch is in the unlatched position (e.g., moved left relative to the page), extension of the blocker to the blocking position may move the latch to the latched position. The linear actuator may be suitably powerful to move the latch to the latched position and secure the door.

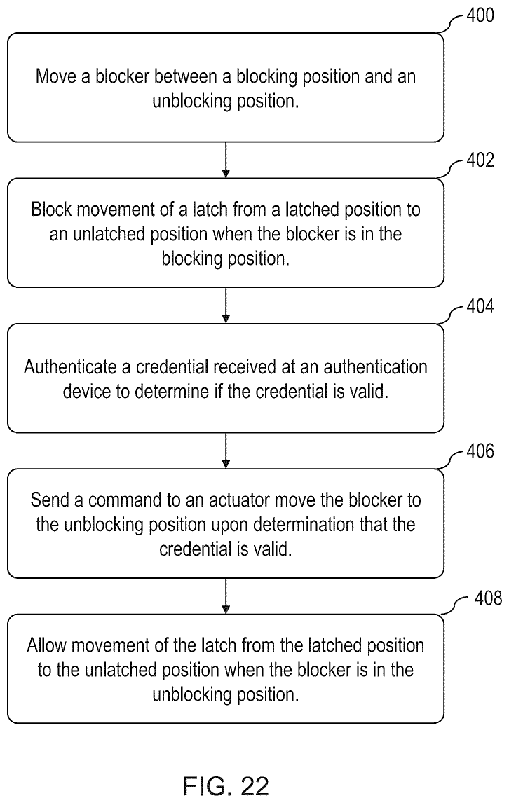

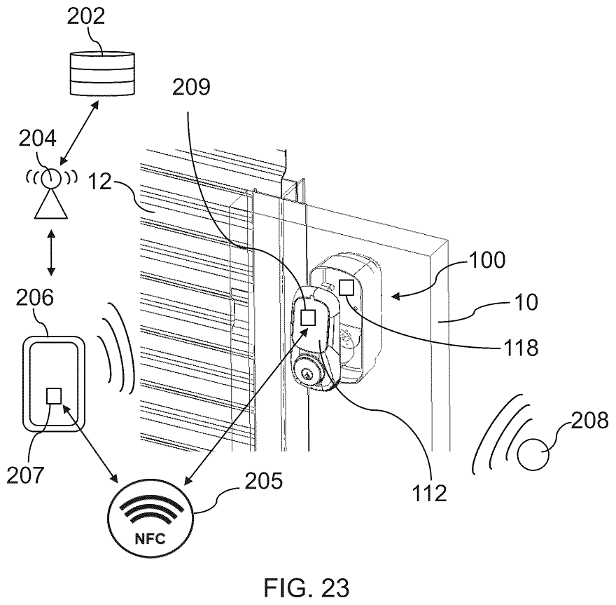

FIG. 22 is a block diagram of one embodiment for a method of operating a roll-up door lock for a roll-up door according to exemplary embodiments described herein. In block 400, a blocker is configured to move between a blocking position and an unblocking position. The blocker may be moved between the blocking and unblocking positions by means of an actuator (e.g., a motor, linear actuator, servo, etc.) that is coupled to the blocker. In block 402, movement of a latch from a latched position to an unlatched position is blocked as a result of the blocker being in the blocking position. As discussed herein, in some embodiments, the blocker may include a pin that is configured to engage with at least one slot provided in the latch such that the blocker may block movement of the latch when the blocker is in the blocking position. In block 404, a credential is received at an authentication device. In some embodiments, the authentication device may communicate with a remote device to receive the credential. For example, the authentication device may comprise an NFC chip that is configured to communicate with an NFC reader in the remote device (e.g., a smartphone) to receive the credential. In some embodiments, the authentication device may include an inductive coupler configured to wirelessly receive power from the remote device. In some such embodiments, the authentication device may be powered solely by the inductive coupler. In some embodiments, the inductive coupler may be configured as a coil of wire that is configured to generate an electric current in response to a magnetic flux through the coil. Such a magnetic flux may be generated by a corresponding coil in a remote device. The power received at the inductive coupler may also be used to energize and operate an actuator, as discussed below. In block 404, the credential is also authenticated to determine whether the credential is valid. In some embodiments, the credential may transmit information (e.g., pin, cryptographic string, token, etc.) to the authentication device, which may determine whether the information is valid and may provide commands and/or send information back to the credential based on that determination.

According to the embodiment of FIG. 22, in block 406, upon determination that the credential is valid, the authentication device sends a command to the actuator (e.g., a motor, linear actuator, servo, etc.) to move the blocker to the unblocking position. While in the depicted embodiment the authentication device may send a command, in other embodiments another integrated circuit or processor of the roll-up door lock may send the command, as the present disclosure is not so limited. In some such embodiments, the authentication device may provide information to the integrated circuit or processor that the credential is valid, which may trigger the integrated circuit or processor to send the command. In block 408, as a result of the blocker being moved to the unblocking position, movement of the latch between the latched and unlatched positions is allowed. In some embodiments, a user may move the latch from the latched position to the unlatched position to allow the roll-up door to open.

According to exemplary embodiments described herein, a roll-up door lock may include a controller, a power source, an authentication device, and an actuator which cooperate to move a blocker between a blocking position and an unblocking position and/or move a latch between a latched position and an unlatched position. The controller may be any suitable processor, microcontroller, or other circuit which is configured to execute instructions stored internally, on a local storage device (e.g., flash storage). The controller may also execute commands received from a remote server via a wired or wireless transceiver which allows the roll-up lock to communicate on a network such as a local area network or cellular network. The power source may be a battery, capacitor, or wired power source which provides power to the controller, authentication device, and the actuator. The authentication device may be configured as an NFC chip, RFID, UWB chip, Bluetooth chip, Wi-Fi chip, or any other suitable device which is capable of receiving and/or communicating with a valid credential. A valid credential may be an authorized remote device (e.g., smartphone), NFC tag or reader, RFID tag, personal computer, smartwatch, and/or any other suitable credential associated with the identity of a user. The authentication device may receive the credential and send a signal to the controller indicating a credential has been received. The controller may compare the credential to a list of authorized credentials to determine if the credential is valid. If the credential is valid, the controller may command the actuator to move a blocker between a blocking position and an unblocking position and/or move a latch between a latched position and an unlatched position. In some embodiments, the controller may communicate with a remote server and receive a command which causes the controller to actuate the actuator, meaning the roll-up lock may be controlled remotely.

FIG. 23 is another embodiment of a roll-up door lock 100, where the roll-up door lock is energized and operated through an inductive coupling. FIG. 23 is similar to the embodiment of FIG. 4, in that the roll-up door lock may be configured to communicate with a plurality of local and remote devices. In FIG. 23, the roll-up door lock is configured to communicate with credential devices and a remote server (e.g. a cloud service) to enable digital management and access of the secured roll-up door. The authentication device 112 may communicate with a remote device 206 via any suitable communications protocol, such as NFC, Bluetooth, RFID, etc. In the embodiment of FIG. 23, a communications module 118 communicates with a remote server 202 via the remote device 206 and a network 204. The network 204 may be any suitable network including, but not limited to local area network, wide area network, cellular network, satellite network, or any other suitable network. The network may communicate through any suitable protocol including, but not limited to Wi-Fi, Ethernet, CDMA, LTE, or any other suitable protocol. The remote server may be used to transmit commands to the roll-up door lock such as lock/unlock commands, setting alteration commands, credential verification commands, etc. The remote server may communicate to the roll-up door lock via the remote device 206. In some embodiments, the commands from the remote server 202 may be encrypted such that they are protected from access on the remote device 206. Such an arrangement may be beneficial where the remote device is a third-party device. The remote server may also receive information from the roll-up door lock via the remote device such as credentials, diagnostic information, access information, etc. The remote server may also allow local communication with the roll-up lock (e.g., via a personal computer or mobile device) so that the roll-up lock may be locked or unlocked from the remote device. For example, the remote service may grant an access token to the remote device 206 to enable the remote device to communicate with and control the roll-up door lock 100.

While in the embodiment of FIG. 23 a distinct communications module 118 and authentication device 112 are included as a part of the roll-up door lock, in other embodiments a communications module 118 and an authentication device may be formed as a part of the same circuit, or their functions may be performed by the same processor(s), as the present disclosure is not so limited.

As discussed above, the roll-up door lock 100 of FIG. 23 is energized and operated through the use of inductive coupling. In FIG. 23, the roll-up door lock 100 includes an NFC chip 209. In some embodiments, the NFC chip 209 may be integrated with the authentication device 112. In other embodiments, the NFC chip 209 may be distinct from the authentication device 112 (e.g., not forming the same component). In this embodiment, the NFC chip 209 is a dynamic (dual-interface) NFC tag capable of two-way communication with a corresponding remote device 206. Specifically, the NFC chip may be configured to communicate with an NFC chip 207 of the corresponding remote device 206 (e.g., a mobile device such as a smartphone) through use of NFC communication protocols 205. Accordingly, the NFC chip 207 of the remote device 206 is formed as an NFC reader in the embodiment of FIG. 23. In some embodiments, the NFC chip may be an inductive coupler configured to form an inductive coupling with the NFC reader of the remote device 206. As discussed above, the inventors have recognized benefits associated with using inductive coupling to energize the one or more components (e.g., an authentication device, actuator, etc.) of the roll-up door lock 100. In such a configuration, the NFC chip 207 of the remote device may be configured to function as a charging transmitter (e.g., a poller) and the NFC chip 209 of the lock 100 may be configured to function as a charging receiver (e.g., a listener). The NFC chip 207 of the remote device may generate a magnetic field that creates a magnetic flux across the NFC chip 209 of the lock 100. Accordingly, each of the transmitter and receiver devices may comprise an induction coil, where an electric current may be passed through the induction coil of the transmitter, thereby generating a magnetic field from the transmitter which in turn is induced in the induction coil of the receiver. As a result, this process of inductive coupling transfers electrical energy to the receiver device (e.g., the lock) wirelessly. In some embodiments, this electric energy may be employed to energize the authentication device and/or actuator of the roll-up door lock 100. In some such embodiments, since the roll-up door lock components are being energized and operated using the induced electrical energy from the remote device, alternative power sources such as batteries, capacitors, and/or wired sources may not be needed in the lock 100. Accordingly, in some embodiments, an inductive coupler of the lock 100 is the sole energy source for the authentication device and/or the actuator.

While in the embodiment of FIG. 23 an inductive coupler is configured as an NFC chip 209, in other embodiments the inductive coupler may be configured as an RFID chip provided in the roll-up door lock. In some such embodiments, an RFID reader may be included within the remote device which may be used to energize the RFID chip provided in the roll-up door lock. As similarly discussed above in reference to inductive coupling through use of NFC, each of the RFID reader and RFID chip may include an induction coil, such that a magnetic field may be generated at the RFID reader that creates a magnetic flux across the RFID chip provided in the lock, thereby transferring electrical energy to the lock to energize and operate the authentication device and/or actuator of the lock. While the disclosure herein has discussed inductive couplers in reference to both NFC and RFID chips, any suitable chips may be used in either the remote device and/or the roll-up door lock to provide inductive coupling including, but not limited to UWB chips.

As described above, the use of inductive coupling may provide electrical energy to energize and permit operation of the authentication device and/or actuator. In some such embodiments, the authentication device may be configured to communicate with the actuator and to command the actuator to selectively move a blocker provided in the roll-up door lock to the unblocking position. As discussed above, in some embodiments, the actuator may be an electromechanical actuator of any suitable type including, but not limited to a motor, a servo, a linear actuator, etc. The inventors have also recognized that in some embodiments where inductive coupling is the sole energy source for the roll-up door lock, it may be beneficial to provide a roll-up door lock arrangement that requires less power. As such, in some embodiments, a more energy-efficient actuator may be used. For example, a piezoelectric motor may serve as the actuator in the roll-up door lock to actuate the blocker between the blocking and unblocking positions. In some embodiments, springs or other biasing members may be integrated within the lock to limit the power required for operation of the actuator. While these specific examples are disclosed, the roll-up door lock may comprise any suitable actuator as the disclosure is not so limited.

In view of the above, the amount of energy required to energize and operate the roll-up door lock components may vary depending on the lock arrangement used. In some embodiments, inductive coupling may provide up to 1 W of energy to power the roll-up door lock components such as the authentication device and/or the actuator. Accordingly, in some embodiments, a suitable amount of energy generation from inductive coupling to energize and operate the roll-up door lock may be less than or equal to 1 W, less than or equal to 0.9 W, less than or equal to 0.8 W, less than or equal to 0.7 W, less than or equal to 0.6 W, less than or equal to 0.5 W, less than or equal to 0.4 W, less than or equal to 0.3 W, less than or equal to 0.2 W, or less than or equal to 0.1 W.

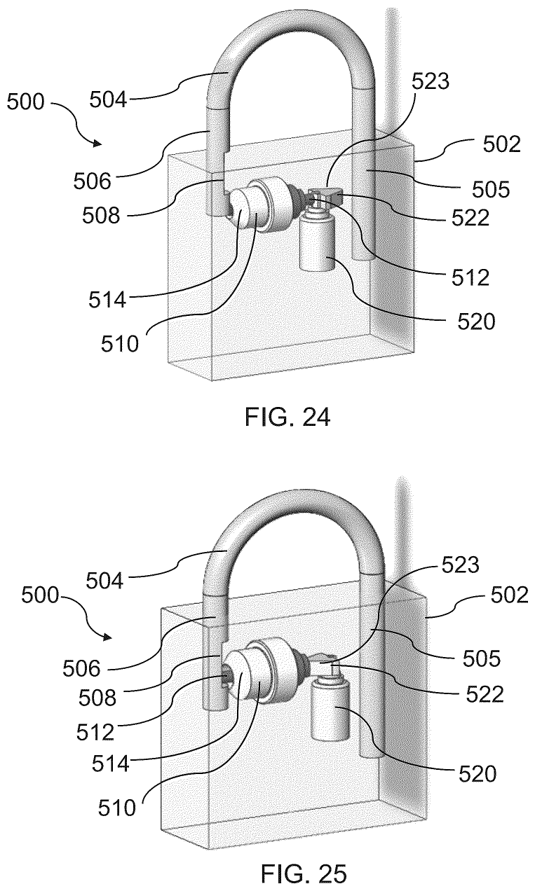

FIG. 24 is a perspective view of an embodiment of a roll-up door lock in an unlocked state. In the embodiments of FIGS. 24-25, the roll-up door lock is configured as a padlock 500, as shown. The padlock 500 includes a padlock body 502 and a latch (e.g., shackle 504). The shackle 504 is configured to move between an unlocked state and a locked state with the respect to the padlock body 502. The shackle 504 includes a proximal end 505 and a distal end portion 506, with a slot 508 being disposed on the distal end portion 506. In some embodiments, the proximal end 505 of the shackle 504 may be permanently affixed to the padlock body 502, while the distal end portion 506 of the shackle 504 may be removably engaged with the padlock body 502.

As shown in FIG. 24, the padlock 500 also includes an actuator 520 which controls an interference element 522 and rotates the interference element 522 into or out of the path of a blocker 512. The blocker 512 is disposed in a blocker carrier 510 which includes a distal carrier portion 514. When the interference element 522 is rotated out of the path of the blocker 512, the blocker is able to move to the retracted position (e.g., the unblocking position), as shown in FIG. 24. In the embodiment of FIG. 24, when the interference element 522 is rotated into the path of the blocker 512, the blocker 512 is actuated into or held in the extended position past the distal carrier portion 514 (e.g., the blocking position, see FIG. 25). The interference element 522 includes inclined camming surfaces 523 configured to move the blocker 512 to the extended position if the blocker is not already in the extended position. In some embodiments, the blocker 512 may engage the slot 508 of the shackle 504 when the blocker 512 is in the extended position to lock the padlock 500. In some such embodiments, in order for the blocker 512 to engage the slot 508, the distal portion 506 of the shackle 504 may be at least partially received into the padlock body 502 to expose slot 508 to the path of blocker 512 (see, for example, FIG. 25) so that the blocker may engage the slot 508. If the distal portion 506 is not sufficiently received in the padlock body 502, as shown in FIG. 24, the padlock may not be able to be locked because the blocker 512 is not able to enter the slot 508. In some embodiments, the slot 508 may be of a greater height than a transverse dimension of the blocker 512 to provide a range of distances over which the blocker 512 may be engaged with slot 508 when the blocker is in the extended position. In the unlocked state, the distal portion 506 of the shackle 504 may be removed from the padlock body 502, thereby permitting the shackle 504 to either engage and be secured to an associated roll-up door, or to be removed from a roll-up door.

Similar to the embodiments discussed with reference to FIGS. 11-14, the blocker carrier 510 may move between a first carrier position and a second carrier position. In the first carrier position, the blocker carrier may be configured to engage the slot 508 formed in the shackle 504. The distal carrier portion 514 may be inclined as shown in FIG. 24 such that movement of the shackle against the blocker carrier may move the blocker carrier to the second blocker position, where the blocker carrier may clear the slot 508 to allow the shackle to move between a locked and unlocked position. The blocker 512 may be biased to an aligned position with the blocker carrier, such that the blocker is configured to move with the blocker carrier unless obstructed by the interference element 522. Accordingly, in the state shown in FIG. 24, the shackle 504 may be moved manually, causing the slot 508 to engage with the distal end portion 514 of the blocker carrier 510 to move the blocker carrier to the second blocker carrier position where the blocker carrier clears the slot. As the blocker 512 is not obstructed by the interference element 522, the blocker is able to move with the blocker carrier and does not block the shackle 504 from moving out of the padlock body 502.

FIG. 25 is a perspective view of the padlock of FIG. 24, with the padlock 500 in the locked state. As noted above, the distal portion 506 of the shackle 504 includes a slot 508. In FIG. 25, the distal portion 506 is shown as being extended into the padlock body 502 such that the slot 508 is engageable with the blocker 512. FIG. 25 also shows the interference element 522 of the actuator 520 rotated into the path of the blocker 512, thereby maintaining the blocker 512 in the extended position such that the blocker 512 remains disposed in the slot 508 to lock the padlock 500. Even if the shackle 504 is moved manually away from the padlock body 502 and the blocker carrier 510 is moved to a second blocker carrier position due to engagement of the inclined distal end portion 514, the blocker 512 is unable to move with the blocker carrier as it is obstructed by the interference element 522. Accordingly, in the locked state, the distal portion 506 may not be removed from the padlock body 502 due to the interference between the slot 508 and the blocker 512.

In some embodiments, the actuator 520 may be an electromechanical actuator of any suitable type including, but not limited to a motor, a servo, a linear actuator, etc. The interference element may also be of any suitable shape and/or size to permit engagement with the blocker when actuated by the actuator. In some embodiments, the actuator and/or interference element may be disposed in a variety of different orientations. For example, in the embodiment of FIGS. 24-25, the actuator 520 and interference element 522 are oriented perpendicularly with respect to a longitudinal axis of the blocker 512 and blocker carrier 510. Such a configuration may permit a more compact profile while still providing sufficient actuation force to actuate the blocker into the extended position. In some embodiments, the actuator may be powered with a battery, capacitor, or wall power. In other embodiments, however, the actuator may be powered by an inductive coupler configured to wirelessly receive power from a remote device, according to embodiments disclosed herein. In some such embodiments, the use of an actuator with low rate of power consumption may permit the lock to be powered entirely from the inductive coupler (e.g., via NFC), and as such, in some embodiments, only the power generated from wireless charging via the remote device may be used.

As discussed above, in some embodiments, the actuator may be an electromechanical actuator of any suitable type including, but not limited to a motor, a servo, a linear actuator, etc.

While embodiments described herein are described with reference to roll-up doors, the roll-up locks of exemplary embodiments may be employed with any suitable door or access point which may be secured with a latch, such as swinging doors, flip up doors, and sliding doors.

Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. A roll-up door lock for a roll-up door, comprising:
a latch configured to move between a latched position and an unlatched position;
a blocker configured to move between a blocking position and an unblocking position, wherein in the blocking position the blocker prevents movement of the latch from the latched position to the unlatched position;
an actuator coupled to the blocker and configured to selectively move the blocker between the blocking position and the unblocking position; and
an authentication device configured to receive a credential and determine if the credential is valid, wherein if the authentication device determines if the credential is valid the authentication device commands the actuator to move the blocker to the unblocking position.

2. The roll-up door lock of claim 1, wherein the authentication device is configured to transmit the credential to a remote server, wherein the remote server is configured to compare the credential to a list of authorized credentials and transmit a signal to the authentication device indicative of whether the credential is valid.

3. The roll-up door lock of claim 1, further comprising an inductive coupler configured to create an inductive coupling with a remote device, wherein the inductive coupling provides electrical energy to energize the authentication device and/or the actuator.

4. The roll-up door lock of claim 3, wherein the inductive coupling is the sole energy source for the authentication device and/or actuator.

5. The roll-up door lock of claim 1, further comprising at least one slot disposed in the latch, wherein the blocker includes a pin configured to engage the at least one slot when the blocker is in the blocking position.

6. The roll-up door lock of claim 1, further comprising a blocker carrier configured to receive the blocker, wherein the blocker carrier has a first blocker carrier position and a second blocker carrier position, wherein the blocker is configured to move independently of the blocker carrier, wherein movement of the latch from the latched position to the unlatched position is configured to cam the blocker carrier from the first blocker carrier position to the second blocker carrier position, and wherein the blocker carrier is biased towards the first blocker carrier position.

7. A method for operating a roll-up door lock for a roll-up door, the method comprising:
moving a blocker between a blocking position and an unblocking position using an actuator coupled to the blocker;
blocking movement of a latch from a latched position to an unlatched position when the blocker is in the blocking position;
authenticating a credential received at an authentication device to determine if the credential is valid;
sending a command from the authentication device to the actuator to move the blocker to the unblocking position upon determination that the credential received at the authentication device is valid; and
allowing movement of the latch from the latched position to the unlatched position when the blocker is in the unblocking position.

8. The method of claim 7, wherein authenticating the credential received at the authentication device includes transmitting the credential to a remote server, comparing the credential to a list of authorized credentials at the remote server, and transmitting a signal to the authentication device to indicate whether the credential is valid.

9. The method of claim 7, further comprising receiving electrical energy from a remote device via an inductive coupling to energize the authentication device and/or the actuator.

10. The method of claim 9, further comprising communicating between the remote device and the authentication device via at least one of NFC and RFID.

11. The method of claim 7, further comprising rolling up the roll-up door when the latch is in the unlatched position.

12. The method of claim 11, further comprising mounting the roll-up door lock to the roll-up door, wherein the roll-up door lock is mounted within a channel of the roll-up door.

13. The method of claim 7, further comprising engaging a pin of the blocker with at least one slot disposed in the latch when the blocker is in the blocking position, wherein sending the command from the authentication device to the actuator causes the actuator to move the pin out of the at least one slot.

14. The method of claim 7, further comprising:
receiving the blocker within a blocker carrier, wherein the blocker carrier has a first blocker carrier position and a second blocker carrier position;
allowing movement of the blocker independently of the blocker carrier; and
camming the blocker carrier from the first blocker carrier position to the second blocker carrier position in response to movement of the latch from the latched position to the unlatched position, wherein the blocker carrier is biased towards the first blocker carrier position.

15. A roll-up door lock for a roll-up door, comprising:
a latch configured to move between a latched position and an unlatched position;
a blocker configured to move between a blocking position and an unblocking position, wherein in the blocking position the blocker prevents movement of the latch from the latched position to the unlatched position;
an actuator coupled to the blocker and configured to selectively move the blocker between the blocking position and the unblocking position; and
an inductive coupler configured to create an inductive coupling with a remote device, wherein the inductive coupling provides electrical energy to energize the actuator, and wherein the remote device is configured to cause the actuator to move the blocker to the unblocking position.

16. The roll-up door lock of claim 15, wherein the inductive coupling is the sole energy source for the actuator.

17. The roll-up door lock of claim 15, further comprising an authentication device configured to receive a credential and determine if the credential is valid, wherein if the authentication device determines if the credential is valid the authentication device commands the actuator to move the blocker to the unblocking position.

18. The roll-up door lock of claim 17, wherein the authentication device is configured to transmit the credential to a remote server, wherein the remote server is configured to compare the credential to a list of authorized credentials and transmit a signal to the authentication device indicative of whether the credential is valid.

19. The roll-up door lock of claim 15, further comprising at least one slot disposed in the latch, wherein the blocker includes a pin configured to engage the at least one slot when the blocker is in the blocking position.

20. The roll-up door lock of claim 15, further comprising a blocker carrier configured to receive the blocker, wherein the blocker carrier has a first blocker carrier position and a second blocker carrier position, wherein the blocker is configured to move independently of the blocker carrier, wherein movement of the latch from the latched position to the unlatched position is configured to cam the blocker carrier from the first blocker carrier position to the second blocker carrier position, and wherein the blocker carrier is biased towards the first blocker carrier position.
